(19) United States
(12) Patent Application Publication
(10) Pub. No.: US 2014/0034432 A1
(43) Pub. Date: Feb. 6, 2014

(54) ELECTRIC BRAKE ACTUATOR FOR VEHICLES

(71) Applicant: Marshall Bull, Wixom, MI (US)

(72) Inventor: Marshall Bull, Wixom, MI (US)

(73) Assignee: ADVICS NORTH AMERICA, Plymouth, MI (US)

(21) Appl. No.: 13/566,822

(22) Filed: Aug. 3, 2012

(51) Int. Cl. B60T 13/74

(52) U.S. Cl. 188/106 R

(57) ABSTRACT

An electric brake actuator configured to be operatively connected to a vehicle brake to operate the vehicle brake includes two electric motors each having an output shaft rotated by operation of the respective motor; an actuator output connectable to the vehicle brake, and a differential operatively connected to the actuator output and to both the output shaft of the first electric motor and the output shaft of the second electric motor to transfer the first and second driving forces to the actuator output by way of the differential.

### TECHNOLOGICAL FIELD

The disclosure here generally pertains to vehicle brakes including parking brakes and service brakes. More specifically, the disclosure involves an electric brake actuator for actuating vehicle brakes through motor-operation.

### BACKGROUND DISCUSSION

Automotive vehicles commonly include a parking brake which is operable to switch between an engaged state and a disengaged state. Somewhat recently, vehicles have been outfitted with electric parking brakes in which the parking brake is switched between the engaged and non-engaged states through operation of a motor. FIG. 1 schematically illustrates a known electric parking brake arrangement in which a single motor M is used in combination with one or more torque multiplication devices P₁, P₂ . . . Pₙ to achieve the desired output for operating the parking brake. The torque multiplication devices are typically in the form of belts, pulleys or a series of gears. The torque multiplication devices increase the torque produced by the motor output, but also reduce the speed.

FIG. 2A illustrates an example of a motor-operated parking brake, sometimes referred to as a motor-on-caliper parking brake. An actuator 12, which includes a motor, is operatively coupled to the brake 10. The caliper portion of the motor-on-caliper converts the rotational motion of the actuator into linear motion. FIG. 2B schematically illustrates a way in which this is accomplished. The actuator 12, under the operation of the motor, rotates a screw (lead screw) 16 which causes linear movement of a nut 18. The nut 18 pushes the caliper piston 20. A thrust bearing exists between the caliper and the screw, and allows the screw to rotate even though a relatively large load is being transmitted from the screw into the caliper. In a known manner, the movement of the piston linearly moves a brake pad toward and into contact with the brake rotor. Another brake pad opposes the one brake pad and contacts the opposite side of the brake rotor. The operation of the actuator 12, including the motor, thus produces a clamping force applied to the brake rotor.

Many known parking brakes utilize a single electric motor to effect operation of the parking brake. This motor must be relatively large to provide the power necessary to achieve the required brake performance. Motors of the size typically used exhibit a relatively low power density compared to smaller motors.

United States Application Publication No. 2003/0205437 proposes an electric brake assembly involving the use of two motors. FIG. 3 schematically illustrates the disclosed arrangement involving the use of a spur gear trains P₁, P₂, P₃ to produce an output. The drive shaft of one motor M₁ engages and rotates the spur gear P₁, while the drive shaft of the other motor M₂ engages and rotates the spur gear P₂. The two spur gears P₁, P2 engage and rotate the third spur gear P₃. The patent application publication states that the disclosed electric brake assembly permits a more compact design and allows two smaller-diameter motors, which exhibit lower inertia, to be used in place of the a larger-diameter single motor. The gear trains have only one input and one output, and so the speeds of the two motors are forced to be a constant ratio of one another.

### SUMMARY

One aspect of the disclosure here involves an electric brake actuator operatively connectable to a vehicle brake to operate the vehicle brake. The electric brake actuator comprises a housing enclosing an interior of the housing, a first electric motor located in the interior of the housing and having an output shaft rotated by operation of the first electric motor to produce a first driving force, a second electric motor located in the interior of the housing and having an output shaft rotated by operation of the second electric motor to produce a second driving force, an output gear rotatable by the first driving force and the second driving force, and a planetary gear train located in the interior of the housing and positioned between the output gear and both the output shaft of the first motor and the output shaft of the second motor to transfer the first driving force and the second driving force to the output gear. The planetary gear train comprises a sun gear and a plurality of planetary gears mounted on a common carrier, with each of the planetary gears rotatably engaging the sun gear.

According to another aspect, an electric brake actuator operatively connectable to a vehicle brake to operate the vehicle brake includes: a first electric motor having an output shaft rotated by operation of the first electric motor to produce a first driving force, a second electric motor having an output shaft rotated by operation of the second electric motor to produce a second driving force, an actuator output connectable to the vehicle brake, and a differential operatively connected to the actuator output and to both the output shaft of the first electric motor and the output shaft of the second electric motor to transfer the first and second driving forces to the actuator output by way of the differential.

A further aspect of the disclosure here involves an electric brake actuator comprising a first electric motor which is operational to rotate an output shaft of the first motor, a second electric motor which is operational to rotate an output shaft of the second motor, a rotatable output operatively connectable to the vehicle brake to operate the vehicle brake, and means for combining torque produced by rotation of the output shaft of the first motor with torque produced by rotation of the output shaft of the second motor to produce a combined torque which is applied to the output to rotate the output, and for allowing the first and second motors to rotate at speeds independent of one another.

### BRIEF DESCRIPTION OF THE DRAWING FIGURES

Additional features and aspects of the electric brake actuator disclosed here will become more apparent from the following detailed description considered with reference to the accompanying drawing figures in which like elements are designated by like reference numerals.

FIG. 1 is a schematic illustration of a known motor assembly used to operate a parking brake.

FIG. 2A is a plan view of a known motor-operated parking brake and

FIG. 2B is a somewhat schematic illustration of aspects of the parking brake actuated by the motor.

FIG. 3 is a schematic illustration of another known motor assembly used to operate a parking brake.

FIG. 4 is a schematic illustration of the electric brake actuator disclosed here.

FIG. 5 is an exploded view of the electric brake actuator disclosed here according to one embodiment disclosed by way of example.

FIG. 6 is a top perspective view of the electric brake actuator shown in FIG. 5.

FIG. 7 is a bottom perspective view of the electric brake actuator shown in FIG. 5.

FIG. 8 is a perspective view of a second embodiment of an electric brake actuator as seen from one side.

FIG. 9 is a perspective view of the electric brake actuator shown in FIG. 8 as seen from an opposite side.

FIG. 10 is an exploded view of a portion of the gear train forming a part of the electric brake actuator shown in FIG. 8, with the motors, mounts and housing not illustrated for purposes of ease in understanding.

FIG. 11 is an exploded view of the electric brake actuator shown in FIG. 8 illustrating power flow during operation of the motors.

FIG. 12 is a plan view of a motor-on-caliper parking brake utilizing the electric brake actuator disclosed here.

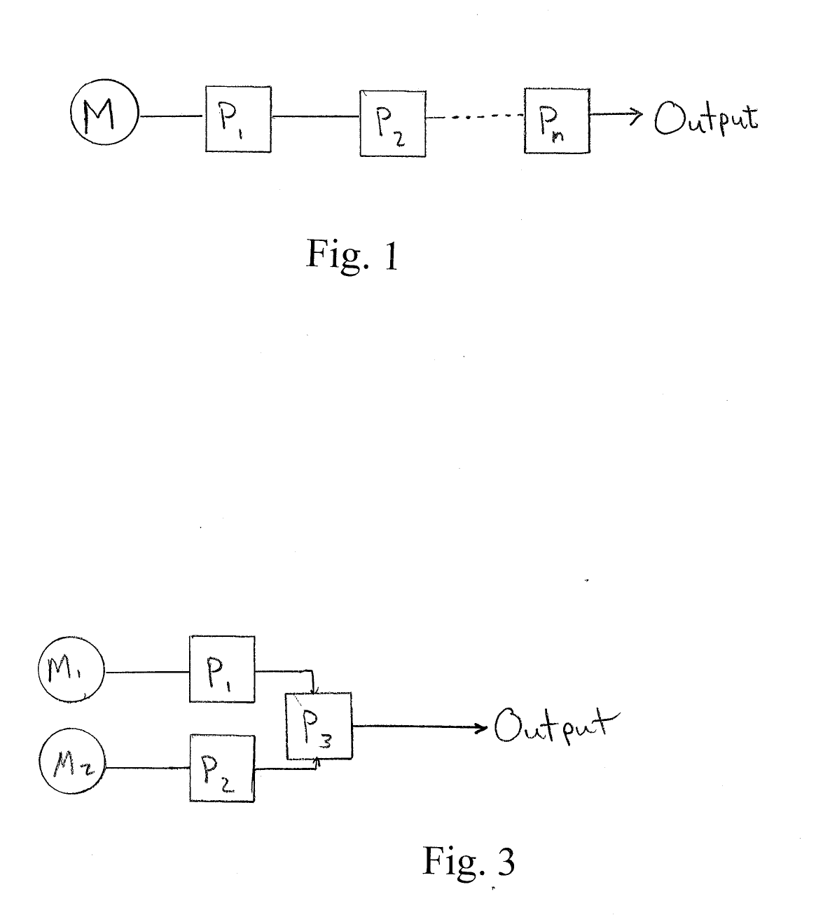

### DETAILED DESCRIPTION

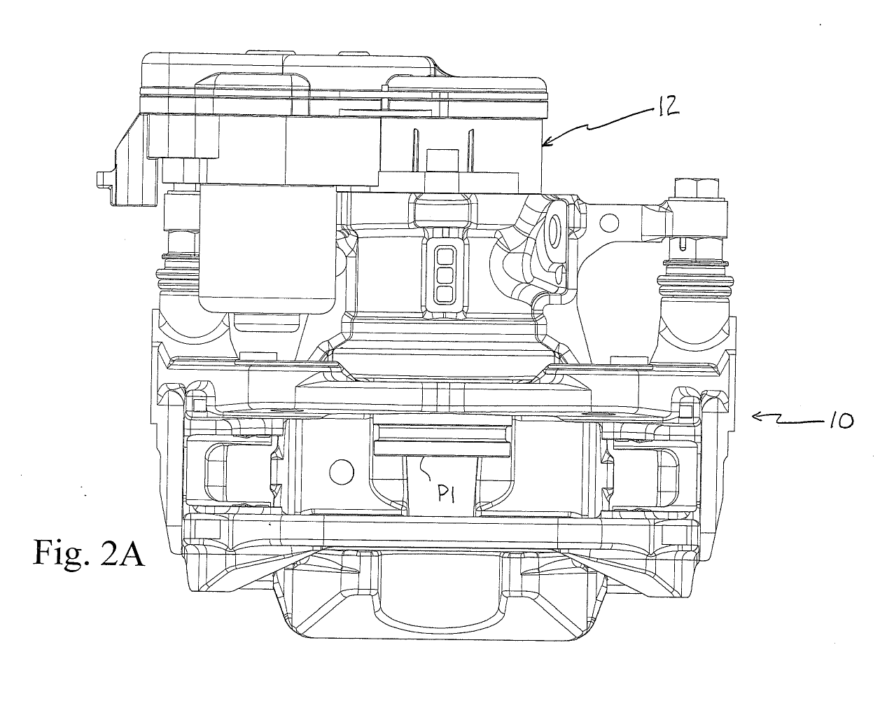

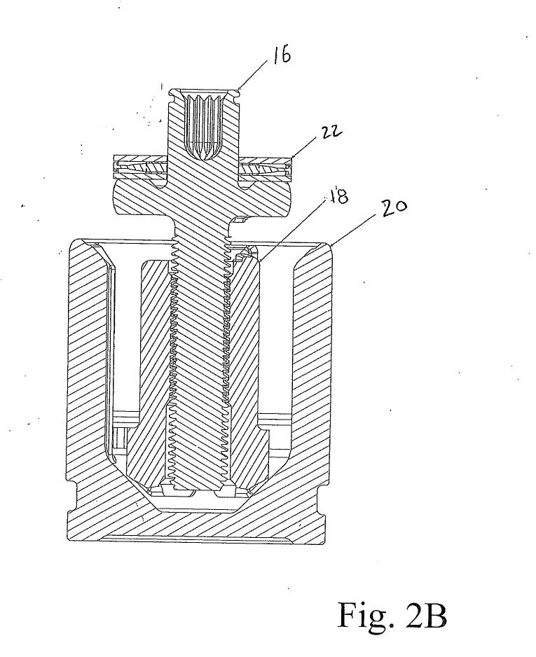

Set forth below is a detailed description the electric brake actuator disclosed here. The electric brake actuator is described and illustrated in terms of several embodiments disclosed as examples of the electric brake actuator. The description which follows describes the actuator used to actuate or operate a parking brake such as the parking brake generally illustrated in FIG. 2, though it is to be understood that the electric brake actuator can also be used to operate or actuate parking brakes of a different type or construction, and can also be used to operate or actuate vehicle service brakes (i.e., the brakes used during normal vehicle driving).

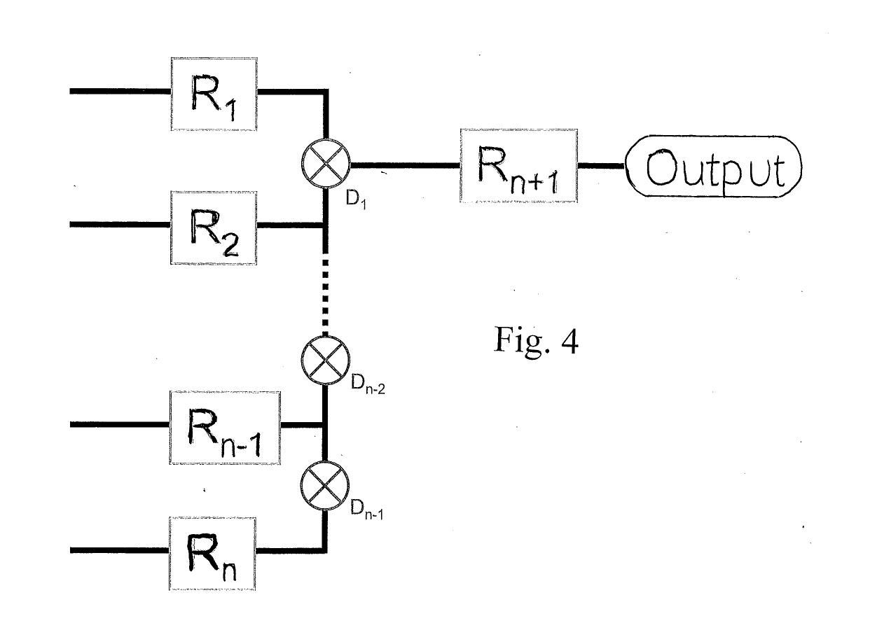

FIG. 4 is a schematic illustration of the electric brake actuator disclosed here. Generally speaking, the electric brake actuator includes a plurality of motors M₁, M₂, Mₙ₋₁, Mₙ in combination with a plurality of torque multiplication devices R₁, R₂, Rₙ₋₁, Rₙ and a plurality of differentials D₁, Dₙ₋₂, Dₙ₋₁, which can also serve as power combining devices. The torque output by each of the respective motors M₁, M₂, Mₙ₋₁, Mₙ is increased by the torque multiplication devices R₁, R₂, Rₙ₋₁, Rₙ, and the increased torque is then combined at the differentials D₁, Dₙ₋₁, Dₙ₋₁. The resulting combined torque can be subjected to further torque multiplication by the torque multiplication device Rₙ₊₁ to produce an output that is used to operate the parking brake.

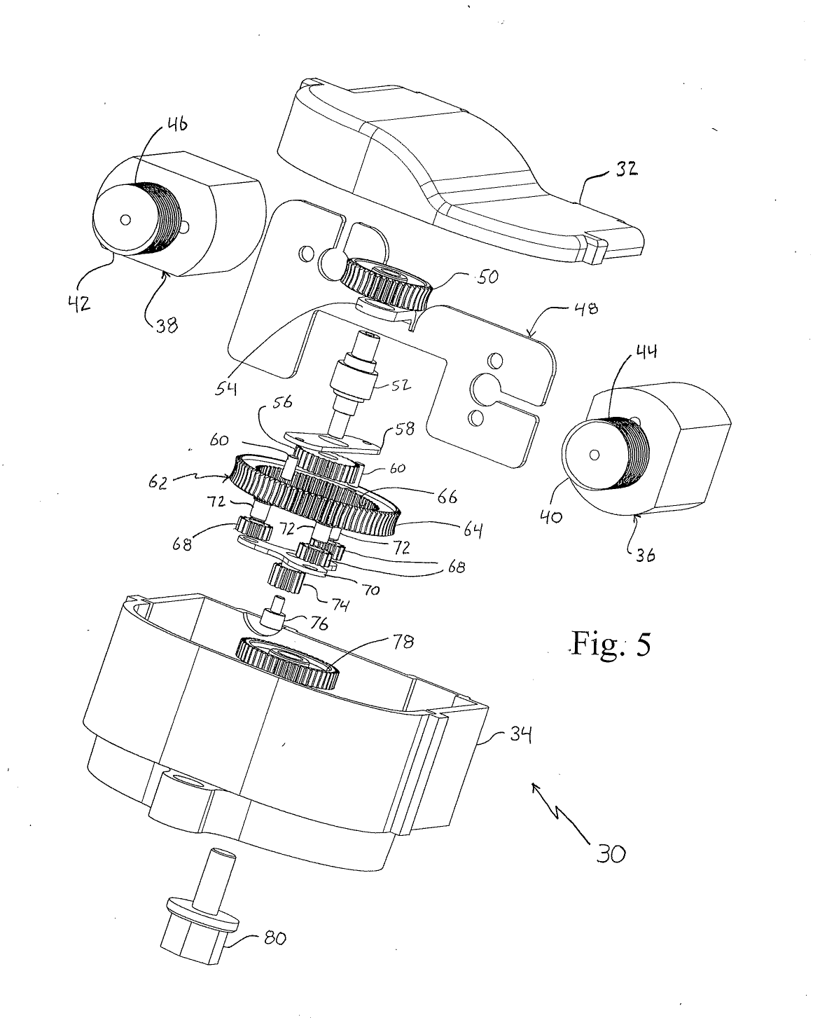

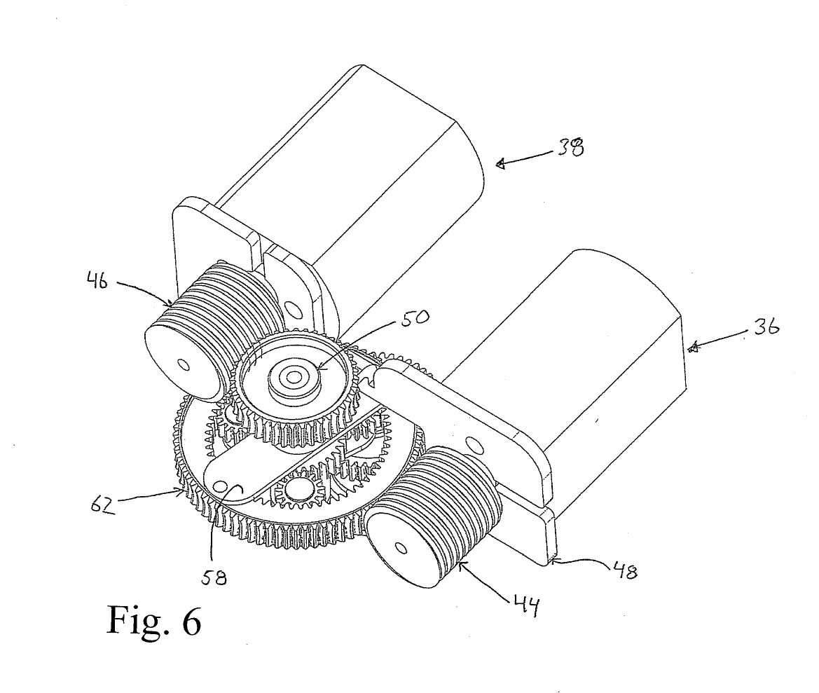

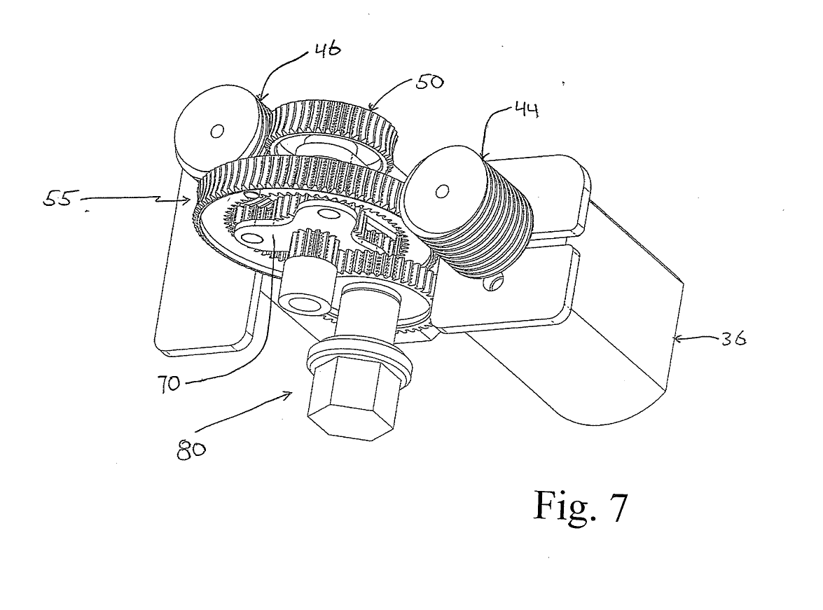

FIGS. 5-7 illustrate an example of one possible arrangement for the electric brake actuator disclosed here and generally illustrated in FIG. 4. Referring to FIGS. 5-7, this embodiment of the electric brake actuator 30 disclosed by way of example includes two housing portions 32, 34 which together define a housing having an interior in which is positioned the illustrated features of the electric brake actuator, except for the actuator output.

The electric brake actuator 30 also includes two motors 36, 38 each positioned in the housing interior and possessing a respective output shaft or drive shaft 40, 42. The output shaft 40, 42 of each motor 36, 38 is provided with a gear 44, 46. Each motor 36, 38 is mounted on a motor mounting bracket 48 which is also positioned in the interior of the housing.

The gear 46 on the output shaft 42 of the one motor 38 is in contact with and engages a gear 50. The gear 50 is fixed to a shaft 52, for example by press-fitting, so that the gear 50 and the shaft 52 rotate together as a unit. The shaft 52 passes through a through hole in a flange 54 of the motor mounting bracket 48 to thus fix the position of the gear 50 relative to the output shaft 42 of the motor 38. The shaft 52 is also fixed to a sun gear 56 so that the shaft 52 and the sun gear 56 rotate together as a unit. By virtue of this construction, the rotation of the output shaft 42 of the motor 38 results in rotation of the gear 50 and the sun gear 56 by way of the shaft 52. The motor 38 thus constitutes a sun motor in that the operation of the sun motor 38 results in rotation of the sun gear 56.

The end of the shaft 52 opposite the gear 50 passes through a through hole in a plate 58. The plate 58 is fixed to a gear part 62 by way of a plurality of pins 60. The pins 60 are press fit into respective holes in the plate 58 and in the gear 62 so that the plate 58, the pins 60 and the gear part 62 rotate together as a unit.

In this illustrated embodiment, the gear part 62 is a dual gear part in which the inner peripheral surface of the gear part 62 is a ring gear 66 and the outer peripheral surface of the gear part 62 is another gear 64. The gear 64 is in contact with and engages the gear 44 on the output shaft 40 of the motor 36 so that rotation of the output shaft 40 rotates the gear 64 and thus the gear part 62. The motor 36 thus constitutes a ring motor in that the operation of the ring motor 36 results in rotation of the ring gear 66.

The ring gear 66 engages a plurality of planet gears 68. In the illustrated embodiment, the ring gear 66 engages three planet gears 68. The planet gears 68 are mounted on a common carrier 70 by way of respective mounting pins 72. The planet gears 68 also engage the sun gear 56. An output gear 74 is fixed to the carrier 70 so that rotation of the carrier 70 results in rotation of the output gear 74. A fixing pin 76 is configured to be fitted into a recessed portion in the end of the shaft 52 facing the fixing pin 76 (i.e., the lower end in FIG. 5) to thus sandwich or hold together the gear assembly.

In the illustrated embodiment, the output gear 74 is operatively connected to an actuator output 80 by way of a further gear 78. The gear 78 provides further gear reduction and torque multiplication. The gear 78 is fixed to the actuator output 80 so that the rotation transferred to the gear 78 results in rotation of the actuator output 80. The actuator output 80 is preferably configured to engage/operate the parking brake. In this illustrated embodiment, the actuator output 80 is configured to engage the screw 16 (lead screw assembly) shown in FIG. 2 to effect operation of the parking brake.

During operation of the electric brake actuator 30, the rotation of the output shaft 42 rotatably drives the gear 50 which in turn drives the gear 56. At the same time, the operation of the motor 36 rotates the output shaft 40 to rotate the gear 62. The rotation of the gear 56 and the rotation of the gear 62 are combined (assuming both motors 36, 38 are operating in the same direction) and result in rotation of the planetary gear unit formed by the planet gears 68 mounted on the common carrier 70. This in turn results in rotation of the output gear 74 which in turn drives the actuator 80 by way of the reduction gear 78.

This electric brake actuator 30 multiplies the torque produced by the plural motors 36, 38 by way of torque multiplication devices such as the gears 44, 64 and 46, 50. The increased torque is then combined by way of a power combining device having multiple inputs and a common output. In this illustrated embodiment, a planetary gear train 55 forms the power combining device and includes the sun gear 56, the ring gear 66 and the planet gears 68 mounted on the common carrier 70. The sun gear 56, the ring gear 66 and the planet gears 68 thus constitute one example of means for combining the torque produced by rotation of the output shaft 42 of the motor 38 with torque produced by rotation of the output shaft 40 of the motor 36 to produce a combined torque which is applied to the output gear 74 to rotate the output gear, while at the same time allowing the two motors 36, 38 to rotate at speeds independent of one another.

The planetary gear train formed by the sun gear 56, the ring gear 66 and the planet gears 68 mounted on the common carrier 70 operate as a differential operatively connected to the output gear 74 and to both the output shaft 40 of the electric motor 36 and the output shaft 42 of the other electric motor 38 to transfer the driving forces or torque produced by each motor to the output gear by way of the differential. The differential allows the motors 36, 38 to operate at speeds which are independent of one another.

The electric brake actuator 30 configured in the manner described above, makes it possible to utilize smaller motors to operate the vehicle brake. Thus, as an alternative to using a single large electric motor to provide the power required to achieve the necessary brake performance, it is possible with the electric brake actuator disclosed here to achieve the required brake performance using smaller motors. The combined volume, mass and cost of several smaller motors is less than the volume, mass and cost of a single larger motor.

As mentioned above, the electric brake actuator at issue here is also desirable as it allows the motors to rotate at speeds which are fully independent of each other. That is, unlike the electric brake assembly disclosed in U.S. Application Publication No. 2003/0205437 in which the speeds of the two motors are not independent of one another, the electric brake actuator 30 disclosed here allows the output shaft of one of the two motors to rotate at one speed while the output shaft of the other motor rotates at a different speed. The electric brake actuator 30 permits one of the motors to operate while the other motor is not operating. This is a significant contrast to the two-motor electric brake assembly described in U.S. Application Publication No. 2003/0205437 which, in the event one of the motors is not operating, for example due to some type of malfunction or damage to the motor, the non-operating motor no longer contributes torque and instead is taking away power produced by the operating motor due to, drag and the like of the non-operating motor. This thus reduces the output of the actuator.

As discussed above, the electric brake actuator 30 uses a power combining device which, in this embodiment disclosed by way of example, is in the form of a differential having multiple inputs connected to or combined at a single output. The differential used in this embodiment is in the form of a planetary gear train allowing the inputs from the two motors 36, 38 to be combined into a common output at the output gear 74. It is to be understood, however, that the disclosure here can be applied to other electric brake actuators employing more than two motors. In an electric brake actuator employing more than two motors, the output of the planetary gear train can be connected to the input of another planetary gear train to form a Simpson's Train, providing one additional input for each additional planetary gear train.

The sun gear 56, the ring gear 66 and the planet gears 68 of the planetary gear train 55 can function as either torque inputs or torque outputs. The speeds of the sun gear, the ring gear and the planet gears must satisfy the characteristic equation for a simple planetary gear train which is as follows:

ωₛᵤₙ+βω_{ring}−(1+β)ω_{carrier}=0; β=N_{ring}/Nₛᵤₙ

where:

ω_{ring}: angular velocity of the ring gear 66

ωₛᵤₙ: angular velocity of the sun gear 56
ω_{carrier}: angular velocity of the carrier 70
β: is a planetary gear train parameter
N_{ring} number of teeth on the ring gear 66
Nₛᵤₙ: number of teeth on the sun gear 56

The above equation demonstrates that the output speed of the planetary gear train (ω_{carrier}) is a function of the two input speeds (ωₛᵤₙ and ω_{ring}).

The electric brake actuator disclosed here allows the parameters of the planetary gear train, and the torque multiplication ratios between the motors 36, 38 and the planetary gear train to be strategically selected to achieve a desired torque split between the two motors 36, 38. The torque relationships associated with a simple planetary gear train are presented by the following equation.

T_{carrier}+(Tₛᵤₙ+T_{ring})=0

where:
T_{carrier} is the carrier torque
Tₛᵤₙ is the sun gear torque
T_{ring} is the ring gear torque

T_{ring}=βTₛᵤₙ, where β=N_{ring}/Nₛᵤₙ=planetary gear train parameter

The torque multiplying device increases the torque applied to the planetary gear train and so taking into account the torque of the motor 38 (Tₛᵤₙ), the gear ratio of the motor 38 (R_{sun motor}), the torque of the motor 36 (T_{ring}) and the gear ratio of the motor 36 (R_{ring motor})

Tₛᵤₙ=R_{sun motor}*T_{sun motor}

T_{ring}=R_{ring motor}*T_{ring motor}

T_{ring}=βTₛᵤₙ which leads to

$$\frac{{T}_{ring motor}}{{T}_{sun motor}} = \frac{β {R}_{sun motor}}{{R}_{ring motor}}$$

This thus shows that the torque relationship between the ring motor 36 and the torque of the sun motor 38 is shared between the two motors in a constant ratio represented by βR_{sun motor}/R_{ring motor}.

From the above equations, it is understood that

T_{ring motor}=T_{sun motor} when R_{ring motor} is equal to βR_{sun motor}.

It is often times desirable or preferable to share the torque equally between the motors (i.e., T_{ring motor}=T_{sun motor}) if both motors are the same. It is thus desirable to select the motor 36 (ring motor) and the motor 38 (ring motor) to satisfy the relationship R_{ring motor}=βR_{sun motor} so that the torque is split evenly between the motors.

In the above described and illustrated embodiment of the electric brake actuator disclosed by way of example, the output shaft 40, 42 of each motor 36, 38 is provided with a gear 44, 46 that engages a respective gear 64, 50 upstream of the planetary gear train 55. The gears 44, 46 and 64, 50 can be spur gears. As an alternative, each output shaft 40, 42 can be outfitted with a worm 44, 46, as illustrated in FIG. 5, that engage respective worm gears 64, 50, as shown in FIG. 5.

The combination of the worms 44, 46 and the worm gears 64, 50 provides additional advantages. In each instance, the combination of the worm and the worm gear operates as an anti-back drive device or self-locking arrangement. By appropriately configuring the helix angle or lead angle on the worms 44, 46, it is possible to prevent back-driving of the motor (i.e., achieve self-locking) in the event operation of one motor is stopped while the operation of the other motor continues. For example, if the motor 36 is not operational, but the motor 38 continues to operate, the motor 38 will drive the sun gear 56. In the absence of an anti-back drive device, the rotation of the sun gear 56 might cause back drive of the motor 36 by virtue of the rotation of the sun gear 56 being transferred to the output shaft 40 of the motor 36 by way of the planet gears 68 and the gear 62. At least some of the torque or power produced by the operating motor would thus be lost to back driving the non-operating motor, thus diminishing effective operation of the brake. As mentioned, utilizing the worm 44, 46 and worm gear 64, 50 arrangement, and properly configuring the helix angle or lead angle of the worms 44, 46 so that rotation of the output shaft of the one operating motor, while the other motor is not operating, does not cause rotation of the output shaft of the non-operating motor, avoids loss of power or torque in instances where one of the motors is not operating. The worms 44, 46 and the worm gears 64, 50 are configured to achieve this self-locking or anti-back drive result.

The self-locking characteristics of the electric brake actuator is achieved by configuring relevant parts of the electric brake actuator so that the lead angle of each worm 44, 46 is less than the inverse tangent of the coefficient of friction between the worm 44, 46 and the worm gear 64, 50 according to the following equation.

λ<tan⁻¹μ; where
λ is the lead angle of the worm; and
μ is the coefficient of friction between the worm and the worm gear.

Configuring the worm gear train of the electric brake actuator as a self-locking worm gear train will allow the worm 44, 46 to drive (rotate) the worm gear 64, 50 while at the same time preventing the worm gear 64, 50 from driving (rotating) the worm 44, 46.

When one of the motors stops operating, the overall system torque multiplication increases. That is, when one of the motors stops operating (spinning), one of the planetary gear elements stops spinning as well, and this causes the torque multiplication of the planetary gear train to increase. This increase in the torque multiplication of the planetary gear train partially or fully compensates for, or offsets, the lost motor torque associated with non-operation of the one motor. The overall system torque multiplication thus increases when one of the motors stops operating.

When both (all) of the motors are stopped, the electric brake actuator becomes mechanically locked. This is desirable from the standpoint that the electric brake actuator meets the regulatory requirement for a parking brake.

If the motor 38 driving the sun gear 56 is not operating (i.e., is not rotating), the carrier torque is proportional to the torque of the motor 36 driving the ring gear 66. As explained above, the characteristic equation for the planetary gear system comprising the sun gear, the carrier, the planetary gears and the ring gear is as follows:

ωₛᵤₙ+βω_{ring}−(1+β)ω_{carrier}=0

If the electric brake actuator is provided with the worm 46 and the worm gear 50 configured as a self-locking or an anti-back drive arrangement, the angular velocity of the sun gear 56 is zero (ωₛᵤₙ=0) and the following relationships hold true when the motor 38 (sun motor) is not operating.

$${ω}_{sun} = 0 ⇒ \begin{matrix}\frac{{T}_{ring}}{{T}_{carrier}} = \frac{{ω}_{carrier}}{{ω}_{ring}} \\ \frac{{ω}_{carrier}}{{ω}_{ring}} = \frac{β}{( 1 + β )}\end{matrix} ⇒ \frac{{T}_{ring}}{{T}_{carrier}} = \frac{β}{( 1 + β )}$$

$${T}_{ring} = {R}_{ringmotor} \underline{* {T}_{ringmotor} ⇒ \frac{{T}_{ringmotor}}{{T}_{carrier}}} = \underline{\frac{β}{{R}_{ringmotor} ( 1 + β )} ⇒ {T}_{carrier}} = \frac{{R}_{ringmotor} ( 1 + β )}{β} {T}_{ringmotor}$$

It is thus seen that when the sun gear is maintained stationary by virtue of the anti-back drive device (i.e., the worm 46 and worm gear 50, and the configuration of the worm and the worm gear do not permit back driving), the torque at the carrier 70 is proportional to the torque produced by the motor 36 (i.e., the ring motor).

On the other hand, if the ring gear 66 is held stationary (ω_{ring}=0) by virtue of the presence of an anti-back drive arrangement (i.e., the presence of the worm 44 and the worm gear 64, and the selection of the appropriate helix angle for the worm), the characteristic equation mentioned above becomes as follows.

$${ω}_{ring} = 0 ⇒ \begin{matrix}\frac{{T}_{sun}}{{T}_{carrier}} = \frac{{ω}_{carrier}}{{ω}_{sun}} \\ \frac{{ω}_{carrier}}{{ω}_{sun}} = \frac{1}{( 1 + β )}\end{matrix} ⇒ \frac{{T}_{sun}}{{T}_{carrier}} = \frac{1}{( 1 + β )}$$

$${T}_{sun} = {R}_{sunmotor} * {T}_{sunmotor} ⇒ \frac{{T}_{sunmotor}}{{T}_{carrier}} = \frac{1}{{R}_{sunmotor} ( 1 + β )} ⇒ {T}_{carrier} = {R}_{sunmotor} ( 1 + β ) {T}_{sunmotor}$$

It is thus seen that with the anti-back drive device holding the ring gear 66 stationary, the carrier torque T_{carrier} is proportional to the sun motor torque T_{sun motor}.

Quite desirably, when one of the motors is not spinning, the torque multiplication of the motor that is spinning is larger than if both motors were operating. This can be seen from the following equation.

β=N_{ring}/Nₛᵤₙ and N_{ring}>Nₛᵤₙ→β>1

When both motors are turning:

T_{carrier}=R_{sun motor}T_{sun motor}+R_{ring motor}T_{ring motor}

When only the sun motor 38 is turning:

T_{carrier}=R_{sun motor}(1+β)T_{sun motor}

When only the ring motor 36 is turning:

T_{carrier}=((R_{ring motor}(1+β))/β)T_{ring motor}

As described above, the desirable condition for equal motor torques with both motors operating is represented by the following equation:

R_{ring motor}=βR_{sun motor} Equation 1

When this relationship is used and only the ring motor 36 is turning:

T_{carrier}=R_{sun motor}(1+β)T_{ring motor}

If both motors are turning, the following relationship holds true:

T_{carrier}=R_{sun motor}T_{sun motor}+βR_{ring motor}T_{ring motor}

When the relationship in Equation 1 is used this becomes:

T_{carrier}=R_{sun motor}T_{sun motor}+βR_{sun motor}T_{ring motor}

And since the relationship in Equation 1 leads to both motor torques being equal,

T_{carrier}=R_{sun motor}(1+β)T_{ring motor}=R_{sun motor}(1+β)T_{sun motor}

To summarize, when the relationship in Equation 1 is used, the output torque (T_{carrier}) when only the sun motor 38 is turning is represented by:

T_{carrier}=R_{sun motor}(1+β)T_{sun motor}

When only the ring motor 36 is turning, the output torque is represented by:

T_{carrier}=R_{sun motor}(1+β)T_{ring motor}

When both motors are turning, the output torque is represented by:

T_{carrier}=R_{sun motor}(1+β)T_{ring motor}=R_{sun motor}(1+β)T_{sun motor}

Therefore, the output torque (T_{carrier}) when only one motor is operating is the same as it is when both motors are operating.

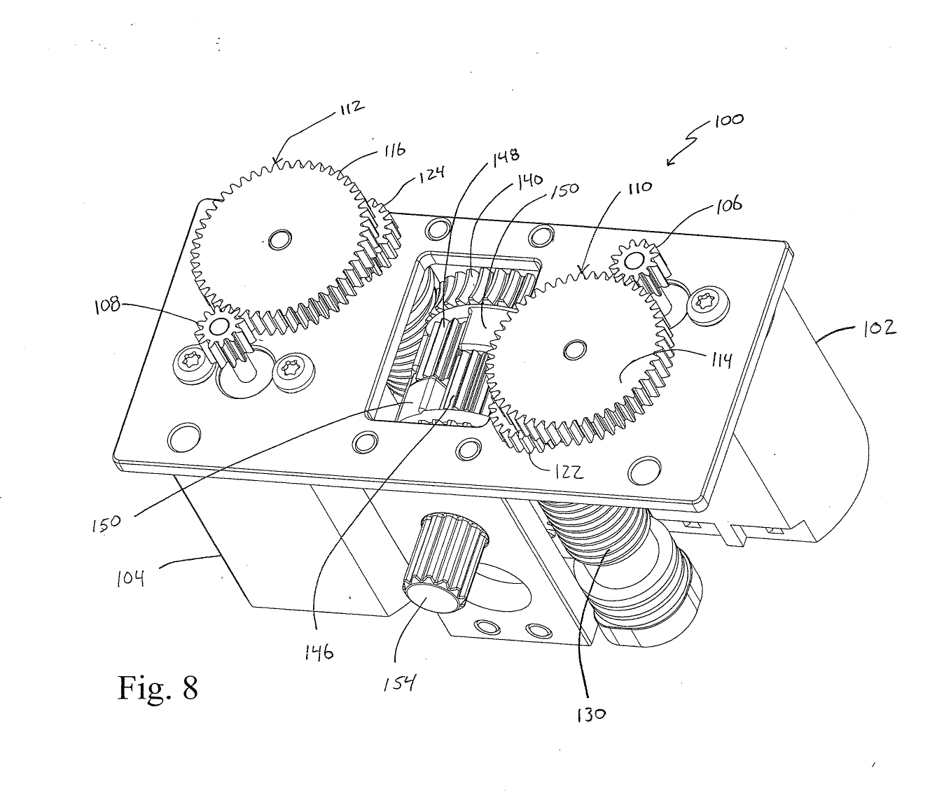

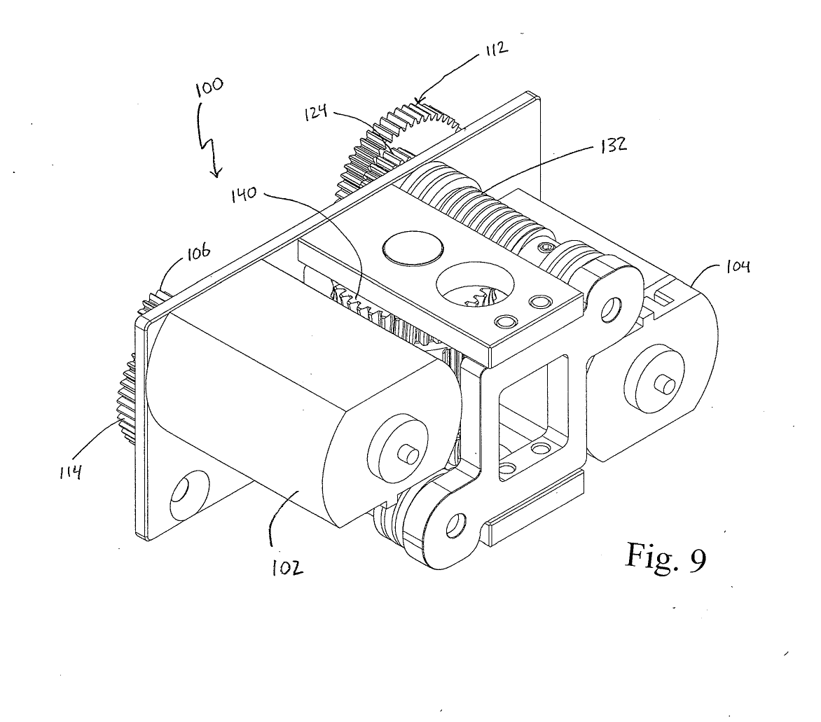

FIGS. 8-11 illustrate another embodiment of the electric brake actuator disclosed as an additional example the electric brake actuator employing multiple motors. This version of the electric brake actuator differs from the example described above and shown in FIGS. 5-7 in various respects, including that the ring gear is replaced with a second sun gear and a seconds set of planet gears. The embodiment of the electric brake actuator shown in FIGS. 8-11 employs a spur gear differential rather than a planetary gear differential as employed in the first embodiment shown in FIGS. 5-7.

Referring to FIGS. 8-11, this second embodiment of the electric brake actuator 100 includes a pair of electric motors 102, 104, with a respective spur gear (small spur gear) 106, 108 fixed to the output shaft of each motor 102, 104. A respective cluster spur gear 110, 112 is positioned between each small spur gear 106, 108 and a respective medium spur gear 122, 124. The cluster spur gears 110, 112 each include a larger gear 114, 116 and a smaller gear 118, 120. Each small spur gear 106, 108 rotatably engages, or meshes with, the larger gear 114, 116 of the respective cluster spur gear 110, 112 so that rotation of the small spur gear 106, 108 results in rotation of the cluster spur gear 110, 112. The smaller gear 118, 120 of each cluster spur gear 110, 112 rotatably engages, or meshes with, the respective medium spur gear 122, 124. The medium spur gears 122, 124 are fixed to a respective shaft 126, 128 to which is fixed a respective worm 130, 132. Rotation of the cluster spur gears 110, 112 thus results in rotation of the worms 130, 132 by way of the medium spur gears 122, 124.

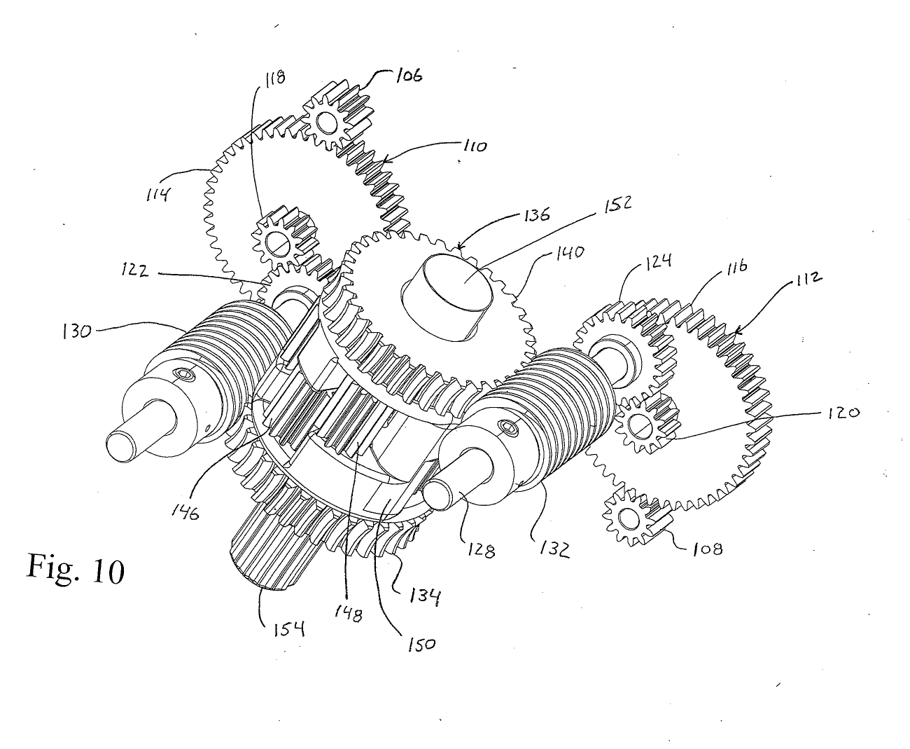

With continued reference to FIGS. 8-11, particularly the FIG. 10 illustration, each of the worms 130, 132 rotatably engages, or meshes with, a respective cluster worm/spur gear 134, 136. That is, the worms 130, 132 mesh with the worm gear 138, 140 of the cluster worm/spur gear 134, 136. The spur gear 142, 144 of each cluster worm/spur gear 130, 134 rotatably engages, or meshes with, the planet gears 146, 148 of respective planetary gear sets. Each planet gear 146, 148 rotates about its own axis. Each spur gear 142, 144 serve as a sun gear that meshes with the respective planet gears 146, 148. The planet gears 146 mesh with the spur gear (sun gear) 142 and also mesh with the planet gears 148. The planet gears 148 mesh with the spur gear (sun gear) 144 and also mesh with the planet gears 146. The planet gears 146, 148 are each mounted on a respective shaft fixed to a carrier 150 (best shown in FIGS. 8 and 10) so that rotation of the spur gear 142, 144 of the cluster worm/spur gear 134, 136 results in rotation of the carrier 150 by way of the planet gears 146, 148. An output shaft 152 is fixed to the carrier 150 and rotates together with the carrier 150. A spline shaft 154 serving as an actuator output is fixed to the shaft 152 and rotates together with the shaft 152. The spline shaft 154 can be integrally formed in one piece as a unitary structure with the shaft 152, or can be separate from the shaft and subsequently connected to the shaft 152. The shaft 152 transmits torque from the carrier 150 to the actuator output 154. The actuator output 154 is configured to engage/operate the parking brake.

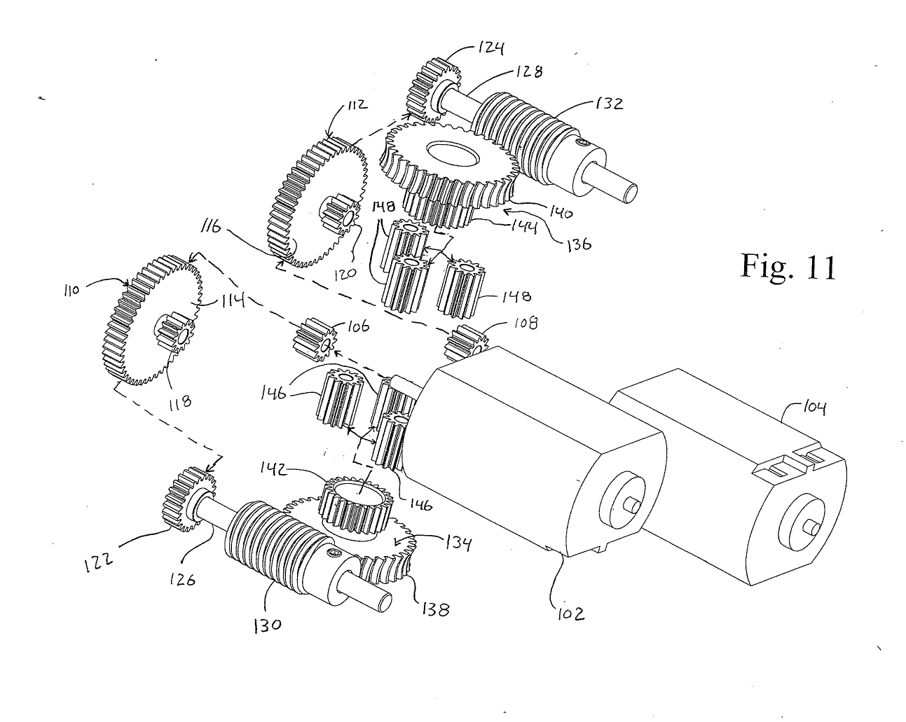

The power flow associated with this second version of the electric brake actuator is generally illustrated in FIG. 11 by the dotted line arrows and is as follows. The operation of each motor 102, 104 rotates the motor output shaft and rotatably drives the small spur gear 106, 108, the rotation of the small spur gear 106, 108 rotates the cluster spur gear 110, 112, the rotation of the cluster spur gear 110, 112 is transmitted to the medium spur gear 122, 124, the rotation of the medium spur gear 122, 124 rotates the worm 130, 132 which in turn rotates the cluster worm/spur gear 134, 136, thus rotating the planet gears 146, 148, the carrier 150, the shaft 152 and the actuator output 154.

In this second version of the electric brake actuator, with both motors operating at the same speed, the torque multiplication occurs by virtue of the small spur gears 106, 108, the cluster spur gears 110, 112, the medium spur gears 122, 124, the worms 130, 132 and the worm gears 138, 140 of the cluster worm/spur gear 134, 136. This torque multiplication occurs before the torque from the two power flows are combined (i.e., before the torque combination). With both motors operating, the torque combination occurs by way of the spur gears 142, 144, the planet gears 146, 148, the carrier 150 and the shaft 152/actuator output 154. This combination of gears thus represents one example of means for combining torque produced by rotation of the output shaft of several motors to produce a combined torque applied to the output. With only one of the motors operating, for example the motor 102, torque is not combined, and the torque produced by the one motor is multiplied by way of the small spur gear 106, the cluster spur gear 110, the medium spur gear 122, the worm 130, the worm gear 138 of the cluster worm/spur gear 134, the planet gears 146 and the carrier 150.

The disclosed example of the arrangement of features forming the electric brake actuator allows both motors 102, 104 to operate together at the same or different speeds, meaning the parking brake can be actuated by operation of both motors 102, 104 at the same or different speeds. Or the parking brake can be actuated by operation of only one of the motors.

This version of the electric brake actuator is further advantageous in that the electric brake actuator exhibits self-locking or anti-back drive characteristics in a manner similar to that discussed above with the first embodiment of the actuator. The self-locking capabilities of the electric brake actuator are provided by the combination of the worms, 130, 132 and the respective worm gears 138, 140. The self-locking capabilities of the electric brake actuator helps ensure that power produced by one of the motors does not flow backwards into the other motor so that the power produced by each motor does not work in opposition to the other motor. Similarly, if only one of the motors is operating, the power produced by the operating motor is not transmitted backward into the non-operating motor. A self-locking worm gear train allows the worm to drive the worm gear, but the worm gear is unable to drive the worm. As explained above, the self-locking characteristics of the electric brake actuator is achieved by configuring relevant parts of the electric brake actuator so that the lead angle of the worm 130, 132 is less than the inverse tangent of the coefficient of friction between the worm and worm gear.

As described above, the electric brake actuator shown in FIGS. 8-11 employs a spur gear differential. The ratio of the input speed of the spur gear differential to the output speed of the spur gear differential satisfies the following relationship.

ωₛᵤₙ₁+βωₛᵤₙ₂−(1+β)ω_{carrier}=0;
where
β=Nₛᵤₙ₂/Nₛᵤₙ₁
ω=the angular velocity of a gear
Nₛᵤₙ₁=the number of teeth of the gear 142
Nₛᵤₙ₂=the number of teeth of the gear 144
   The above equation expresses the relationship between the speed of the inputs (i.e., the speed of the spur gears 142, 144 of the cluster worm/spur gears 134, 136) to the speed of the output (i.e., the carrier 150).

When the spur gears 142, 144 are the same size, β=1 and so the above equation becomes:

ω_{carrier}=(ωₛᵤₙ₁+ωₛᵤₙ₂)/2

Thus, the output speed of the carrier 150 is the average of the input speeds of the two spur gears 142, 144.

If the speeds of the two spur gears 142, 144 are of the same magnitude and the same direction,

ωₛᵤₙ₁=ωₛᵤₙ₂; and so

ωₛᵤₙ₁/ω_{carrier}=ωₛᵤₙ₂/ω_{carrier}=1

This shows that when the speeds of the two spur gears 142, 144 are of the same magnitude and the same direction, the output speed of the carrier 150 is the same as the input speeds spur gears 142, 144 so that the differential behaves like a torque combiner only. That is, the differential simply combines the two inputs.

On the other hand, if the speed of the spur gear 142 is zero, the relationship between the input speed to the output speed is represented as:

ωₛᵤₙ2/ω_{carrier}=2

Similarly, if the speed of the spur gear 144 is zero, the relationship between the input speed to the output speed is represented as:

ωₛᵤₙ₁/ω_{carrier}=2

These two relationships show that if one of the two spur gears 142, 144 is held stationary, the differential operates as a torque multiplier only. When one of the motors 102, 104 is not operating, the worm 130, 132 associated with the non-operating motor holds the associated spur gear 142, 144, thus exhibiting the self-locking or anti-back drive characteristics discussed above.
In the above-examples, when the relationship β=1 exists, the speed reduction and torque multiplication is 2.

If the speeds of the spur gears 142, 144 are of the same magnitude, but opposite direction, ωₛᵤₙ₁=−ωₛᵤₙ₂, and so ω_{carrier}=0. With non-zero input speeds (i.e., with the motors operating), an output speed of zero can thus be achieved.

The electric brake actuator according to this second embodiment includes a gear train that is symmetrical. That is, the gears and arrangement of the gears between the motor 102 and the carrier 150 is symmetrical to the gears and arrangement of gears between the motor 104 and the carrier 150. This embodiment of the electric brake actuator thus makes it possible to reduce costs by using the same gears for the two gear trains.

This second version of the electric brake actuator possesses a smaller mass and volume compared to the first embodiment described above and shown in FIGS. 5-7.

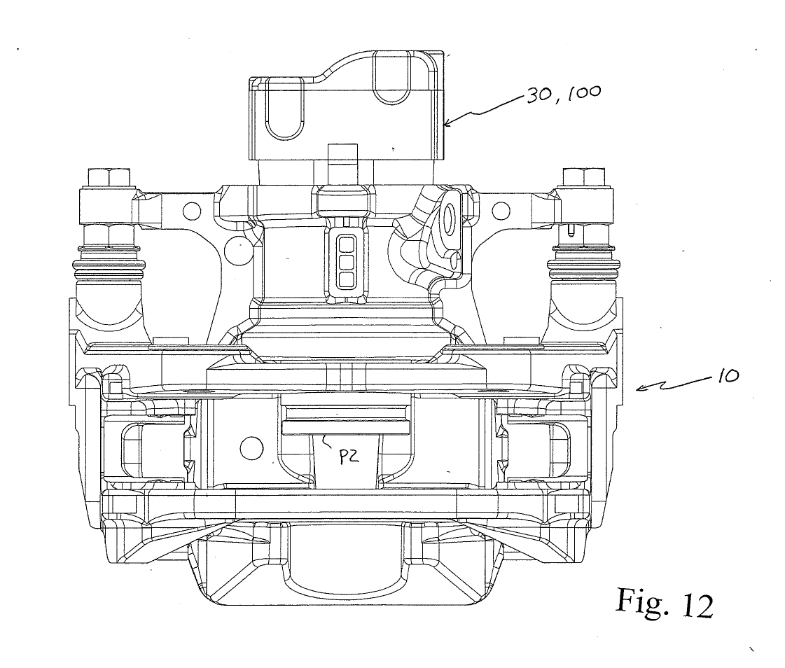

Another advantage associated with the electric brake actuator disclosed here is that its smaller size, compared for example to the known actuator shown in FIG. 2A, allows the actuator to be positioned completely behind the piston and so the electric brake actuator can be configured independently of the cylinder size. This positioning of the actuator 30, 100 completely behind the piston P2 is illustrated in FIG. 12, and can be compared to the positioning of the piston P1 in FIG. 2A. Even if the piston size changes, the same actuator can be used. This is not the case with known brake-on-caliper constructions such as shown in FIG. 2A. In these known constructions, the actuator 12 is mounted to the side of the piston P1 (i.e., is offset relative to the piston) and so pistons of different size, which are required for different vehicles, require a different actuator. The actuator 30, 100 disclosed here can thus be symmetrically positioned relative to the central axis of the piston P2.

Constructing the electric brake actuator to include multiple motors arranged in the manner disclosed by way of example here means that the motors are redundant. If one of the motors becomes non-operational, the other motor is able to operate the parking brake and apply the brake force. By using spur gears (sun gears) 142, 144 configured so that the magnitude and direction of the speeds of the two gears 142, 144 are the same, it is possible to achieve a gear ratio with only one motor operating that is twice (double) that of the gear ratio when both motors are operating. Thus, even if one of the motors is not operating, the output torque achieved with both motors operating can still be maintained.

The disclosed electric brake actuator also exhibits reduced power consumption compared to known actuators, and peak currents are reduced. It is also possible to configure the electric brake actuator so that the motors begin operating at different times. The vehicle will thus not experience the inrush current of both motors simultaneously. This can also help reduce EMI generated by the electric brake actuator.

The detailed description above describes features and aspects of embodiments of an electric brake actuator disclosed by way of example. The invention is not limited, however, to the precise embodiments and variations described. Changes, modifications and equivalents can be employed by one skilled in the art without departing from the spirit and scope of the invention as defined in the appended claims. It is expressly intended that all such changes, modifications and equivalents which fall within the scope of the claims are embraced by the claims.

What is claimed is:

1. An electric brake actuator operatively connectable to a vehicle brake to operate the vehicle brake, the electric brake actuator comprising:
a housing enclosing an interior of the housing;
a first electric motor located in the interior of the housing and having an output shaft rotated by operation of the first electric motor to produce a first driving force;
a second electric motor located in the interior of the housing and having an output shaft rotated by operation of the second electric motor to produce a second driving force;
an output rotatable by the first driving force and the second driving force;
a planetary gear train located in the interior of the housing and positioned between the output and both the output shaft of the first motor and the output shaft of the second motor to transfer the first driving force and the second driving force to the output; and
the planetary gear train comprising a sun gear and a plurality of planet gears mounted on a common carrier, each of the planet gears rotatably engaging the sun gear.

2. The electric brake actuator according to claim 1, wherein the output shaft of the first motor engages a first worm gear, and the output shaft of the second motor engages a second worm gear.

3. The electric brake actuator according to claim 1, wherein the carrier is fixed to the output so that the output and the carrier rotate together as a unit.

4. The electric brake actuator according to claim 1, further comprising, in addition to the planetary gear train, a plurality of gears positioned between the carrier and the output shaft of each of the first and second motors, the plurality of gears and the planetary gear train being symmetrical.

5. The electric brake actuator according to claim 1, further comprising a first worm meshing with a first worm gear that is fixed to a first spur gear constituting the sun gear and a second worm meshing with a second worm gear that is fixed to a spur gear.

6. The electric brake actuator according to claim 5, further comprising a plurality of planet gears meshing with the spur gear.

7. The electric brake actuator according to claim 1, wherein the sun gear is a first sun gear, and the planet gears are first planet gears mounted on the common carrier, further comprising a plurality of second planet gears mounted on the common carrier and meshing with a second sun gear.

8. An electric brake actuator operatively connectable to a vehicle brake to operate the vehicle brake, the electric brake actuator comprising:
a first electric motor having an output shaft rotated by operation of the first electric motor to produce a first driving force;
a second electric motor having an output shaft rotated by operation of the second electric motor to produce a second driving force;
an actuator output connectable to the vehicle brake; and
a differential operatively connected to the actuator output and to both the output shaft of the first electric motor and the output shaft of the second electric motor to transfer the first and second driving forces to the actuator output by way of the differential.

9. The electric brake actuator according to claim 8, wherein the differential comprises a first worm gear and a second worm gear, the output shaft of the first electric motor including a first worm that engages the first worm gear so that operation of the first electric motor rotates the first worm which rotates the first worm gear, the output shaft of the second electric motor including a second worm that engages the second worm gear so that operation of the second electric motor rotates the second worm which rotates the second worm gear.

10. The electric brake actuator according to claim 9, wherein the differential further comprises a sun gear and a plurality of planetary gears engaging the sun gear.

11. The electric brake actuator according to claim 10, wherein each of the plurality of planetary gears is mounted on a common carrier and is rotatable about a respective rotation axis.

12. The electric brake actuator according to claim 11, wherein the carrier is fixed to an output so that the carrier and the output rotate together as a unit.

13. The electric brake actuator according to claim 8, wherein the differential comprises a first worm meshing with a first worm gear and rotatably driven by operation of the first electric motor and a second worm meshing with a second worm gear and rotatably driven by operation of the second electric motor.

14. The electric brake actuator according to claim 13, wherein the differential further comprises a first sun gear fixed to the first worm gear to rotate together with the first worm gear and meshing with a plurality of first planet gears, the differential further comprising a second sun gear fixed to the second worm gear to rotate together with the second worm gear and meshing with a plurality of second planet gears.

15. An electric brake actuator operatively connectable to a vehicle brake to operate the vehicle brake, the electric brake actuator comprising:
a first electric motor which is operational to rotate an output shaft of the first motor;
a second electric motor which is operational to rotate an output shaft of the second motor;
a rotatable output operatively connectable to the vehicle brake to operate the vehicle brake; and
means for combining torque produced by rotation of the output shaft of the first motor with torque produced by rotation of the output shaft of the second motor to produce a combined torque which is applied to the output to rotate the output, and for allowing the first and second motors to rotate at speeds independent of one another.

16. The electric brake actuator according to claim 15, wherein the means comprises a plurality of planetary gears mounted on a common carrier.

17. The electric brake actuator according to claim 16, wherein the means further comprises a sun gear which is contacted by each of the planetary gears.

18. The electric brake actuator according to claim 15, wherein the means comprises a sun gear rotationally fixed to a worm gear that is engaged by the output shaft of the first motor so that rotation of the output shaft rotates the worm gear.

19. The electric brake actuator according to claim 18, wherein the means further comprises three planetary gears mounted on a common carrier and each in contact with the sun gear.

20. The electric brake actuator according to claim 19, wherein the output is fixed to the carrier so that the output and the carrier rotate together.
